(19) United States
(12) Patent Application Publication
(10) Pub. No.: US 2010/0161478 A1
(43) Pub. Date: Jun. 24, 2010

(54) Computer payment banking system and method

(75) Inventors: Ross M. Cavanaugh, Harrisburg, NC (US); Michael T. Duke, Monroe, NC (US); Dean Patrick Nolan, Charlotte, NC (US)

Correspondence Address: Wells Fargo;c/o K& L Gates, Hearst Tower, 47th Floor, 214 North Tryon Street, Charlotte, NC, 28202, US

(73) Assignee: Wachovia Corporation, Charlotte, NC (US)

(21) Appl. No.: 12/316,930

(22) Filed: Dec. 18, 2008

(51) Int. Cl. G06Q 20/00; G06Q 40/00

(52) U.S. Cl. 705/39

(57) ABSTRACT

A computer payment banking system comprising a bank or financial institution, a sourced bank account, a sourced bank account holder, and a merchant. The bank or financial institution uses monetary funds from the sourced bank account to pay the merchant. The system is directed to processing of an online web-based purchase associated with the sourced bank account or holder. The system is directed to processing purchases made using a credit or debit instrument associated with the sourced bank account. A source of monetary funds for the sourced bank account includes, but is not limited to, a checking account, credit or debit instrument, online banking account, bank or non-bank line of credit, loan, financial account, and a combination thereof. Online access to rewards, financial reports, budget tools, or spending information of the sourced bank account holder may be provided by the bank or financial institution to the sourced bank account holder.

### FIELD OF THE INVENTION

The present invention relates to a computer payment banking system and method, more particularly to a computer payment banking system and method suitable for use in a web-based environment.

### BACKGROUND OF THE INVENTION

Many users of the internet and world-wide-web are reluctant to make purchases online. These potential consumers are fearful of disclosing and providing confidential payment information and other personal financial information online. Thus, there are a large number of consumers who do not presently make purchases online but could if he or she had more confidence in the security associated therewith. There are also, however, a large number of consumers who do make online purchases yet still desire for greater security and convenience associated with such purchases.

There are existing web-based services to facilitate payment between consumers and online merchants. For example, many of these payment services are merely money services that act as middlemen to provide no other service and/or function to the consumer other than to switch funds between the consumer and the merchant. However, there are disadvantages associated with such money services to the consumer. For example, many of them are unregulated yet hold funds of the consumer in their own corporate accounts until they are spent and/or transferred to a merchant or vendor. All funds are held by the middleman and are placed into the bank accounts of the middleman. The consumer account holders do not receive any of the interest gained on their money. Furthermore, these middlemen are merely money services that do not hold any physical money and thus are not insured by the Federal Deposit Insurance Corporation (FDIC). Thus, the consumer runs the risk that his or her funds are uninsured and unsecured.

Furthermore, such middlemen money services are also often disadvantageous to the merchants. For example, when a merchant accepts a charge from a card, the merchant pays interchange. Interchange is comprised of a variety fees paid to different parties that have a part in the transaction such as the credit card company, merchant's bank, card issuer, among others. The middleman handles all the transactions between these parties and pays the interchange. The middleman makes money on fees charged for receiving money and interest collected on money left in the middleman's bank accounts.

Referring to the Figures, FIG. 1 illustrates an existing system for a money service in which the money service serves as a middleman merely switching funds between stored value accounts of one or more consumers, merchants, and bank which holds the funds of the money service. By way of background, a stored value account refers to an account that stores monetary value and is not an account of a bank or other financial institution. Examples of stored value accounts include, but are not limited to, a prepaid phone card, and a gift card. A stored value account is an unregulated account. As shown in the example set forth in FIG. 1, the middleman money service is associated with numerous stored value accounts, a merchant(s), and a bank of the money service. As illustrated in FIGS. 1 and 2, the money service switches money and/or credit from these stored value accounts to a merchant(s). Money collected by the money service from interchange during these transaction resides in a bank account of the money service along with the funds of the stored value accounts.

As mentioned above, many of these monetary transactions are credit and/or debit transactions. FIG. 3A represents a typical example of a credit or debit route for a VISA or MasterCard transaction. The parties to an authorization and a settlement VISA or MasterCard transaction typically comprise a purchaser, a merchant, an optional International Sales Organization (ISO), a merchant acquirer, VISA/MasterCard, an optional issuer processor, an issuer, and a source of funds. A series of events occurs for each VISA/MasterCard transaction using a VISA/MasterCard payment card used at a merchant point of sale (POS) terminal. Interchange is charged among the parties to this transaction. FIG. 3B is a flow diagram illustrating the current industry process for authorization of a VISA/MasterCard transaction. FIG. 3C is a flow diagram illustrating the current industry process for settlement of a VISA/MasterCard transaction. In the authorization process, as shown in FIG. 3B, a purchaser uses a VISA/MasterCard payment card to pay for goods or services at a merchant point of sale (POS) terminal, the transaction is captured by an ISO or a merchant acquirer. An ISO is an independent sales organization that is a reseller of acquirer services. A merchant acquirer is typically a bank member of a card network that collects payments on behalf of a merchant. The transaction is then routed by the merchant acquirer to the computer payment network which, in this example, is VISA or MasterCard. The transaction is then routed to an issuer. The issuer is typically a bank member of a card network that issues network approved cards. The issuer may approve or deny a transaction based upon the presence of fraudulent activity or upon funds availability. The funds availability is communicatively connected to a source of funds as shown in FIG. 3A. The transaction is either approved or declined and returned to the merchant POS terminal.

With respect to the process for settlement shown in FIG. 3C, VISA/MasterCard facilitates settlement between the merchant acquirer and issuer. The merchant acquirer then settles with the merchant. The issuer then settles with the purchaser using the funding source that is linked to the VISA MasterCard payment card. Thus, there are numerous disadvantages associated with this consumer transaction for both the consumer and the merchant including the processing time due to the number of parties to a transaction and the amount of interchange that has to be paid to conduct such a transaction.

Accordingly, there is a need for an alternative system and method for conducting computer payment transactions, especially web-based computer payment transactions, that address the disadvantages associated with existing payment systems and services.

### SUMMARY OF THE INVENTION

The present invention relates to a computer payment banking system. The computer payment banking system generally comprises a bank or a financial institution, a sourced bank account, a holder of a sourced bank account, and a merchant. The bank or financial institution uses monetary funds from the sourced bank account to pay the merchant on behalf of the holder of the sourced bank account. The computer payment banking system is directed to processing of an online web-based purchase or refund associated with the sourced bank account or holder of the sourced bank account. The computer payment banking system is also directed to processing purchases or refunds made using a credit or debit instrument associated with the sourced bank account in a computer-based payment system. A source of monetary funds for the sourced bank account includes, but is not limited to, a checking account, credit or debit instrument, online banking account, bank or non-bank line of credit, loan, financial account, and a combination thereof. Online access to rewards, financial reports, budget tools, or spending information of the sourced bank account holder may be provided by the bank or financial institution to the sourced bank account holder.

The present invention also relates to a method of using the computer payment banking system. The method comprises establishing a sourced bank account with a user by a bank or a financial institution that holds physical monetary funds. The user is the holder of the sourced bank account. The method also comprises processing payments in the computer-based payment system using the sourced bank account for purchases or refunds made that are associated with the sourced bank account. The source or sources of monetary funds for the sourced bank account are preferably prearranged between the bank or the financial institution and a holder of the sourced bank account prior to a web-based payment transaction being processed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a diagram illustrating an existing system for a money service in which the money service serves as a middleman merely switching funds between stored value accounts of one or more consumers, merchants and bank which holds the funds of the money service.

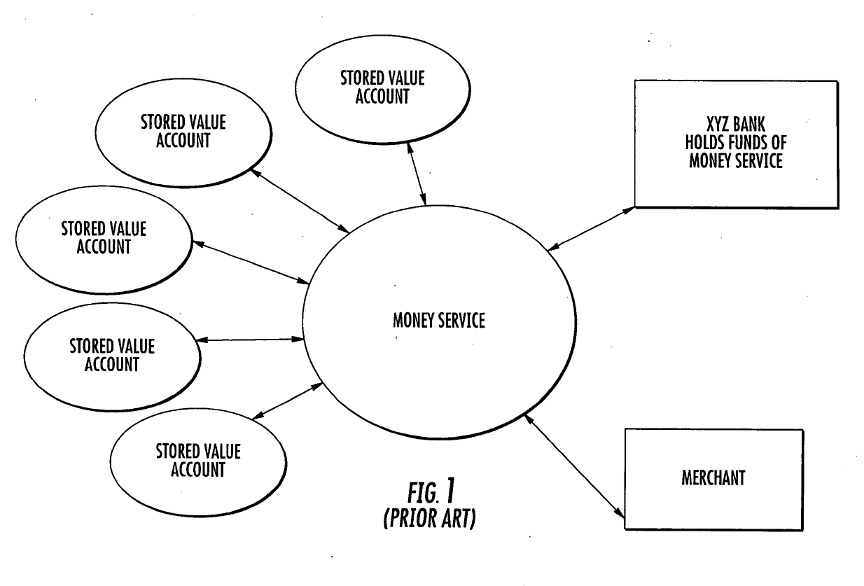

FIG. 2 is a diagram further illustrating the money service of FIG. 1 switching money and/or credit from a stored value account(s) to a merchant(s).

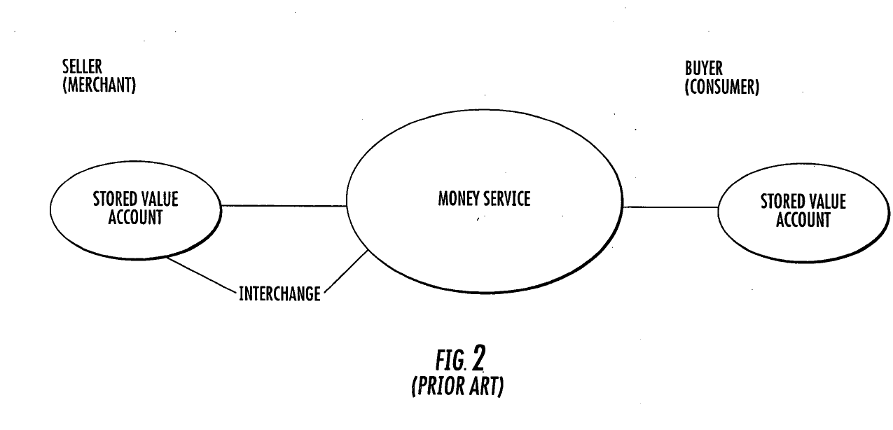

FIG. 3A is a flow diagram representing a typical credit or debit route for a VISA or MasterCard transaction.

FIG. 3B is a flow diagram illustrating the current industry process for authorization of a VISA/MasterCard transaction.

FIG. 3C is a flow diagram illustrating the current industry process for settlement of a VISA/MasterCard transaction.

FIG. 4 is a flow diagram illustrating the computer payment banking system of the present invention.

FIG. 5 is a flow diagram illustrating a method of using the computer payment banking system in accordance with the present invention.

### DETAILED DESCRIPTION OF THE INVENTION

The following detailed description of the embodiment(s) is merely exemplary in nature and is in no way intended to limit the invention, its application, or uses.

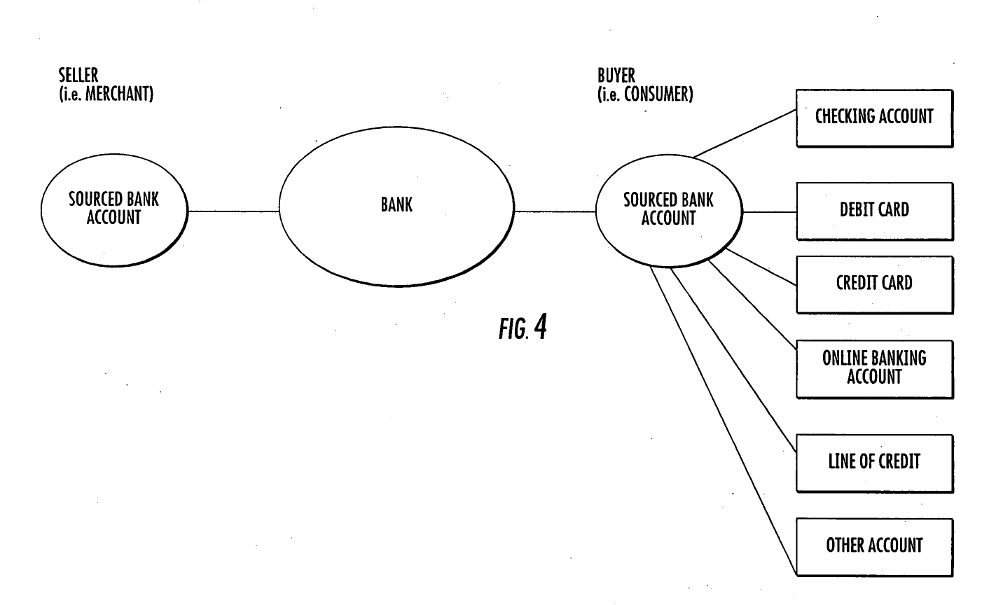

The present invention is directed to a computer payment banking system. The computer payment banking system of the present invention generally comprises a bank or other regulated financial institution, a sourced bank account, a holder of a sourced bank account, and a merchant. As shown in FIG. 4, the bank serves as a payment processor for a purchase or a refund made from a merchant using the sourced bank account. A sourced bank account is an account that is established by a bank or other regulated financial institution. Unlike money services that merely process payments, a bank holds physical monetary funds. Preferably, the sourced bank account is a bank account that is used for the sole or primary purpose of sourcing payment for purchases made by the holder of the sourced bank account. Also, as shown in FIG. 4, the sourced bank account is sourced with funds from a number of sources including, but not limited to, a checking account, credit instrument, debit instrument, online banking account, bank line of credit, non-bank line of credit, loan, financial account, and a combination thereof. The holder of the sourced bank account may or may not be an existing customer of the bank or financial institution. The holder of the sourced bank account is a person or entity who enrolls and is approved for a sourced bank account. Preferably, the holder of the sourced bank account is issued a credit or debit instrument such as a credit card or debit card associated with the sourced bank account that can be used for purchases, online or otherwise, that are processed by the bank or other regulated financial institution using the sourced bank account. As a feature of the system of the present invention, the bank or the financial institution provides online access to rewards, financial reports, budget tools, or spending information of the holder of the sourced bank account.

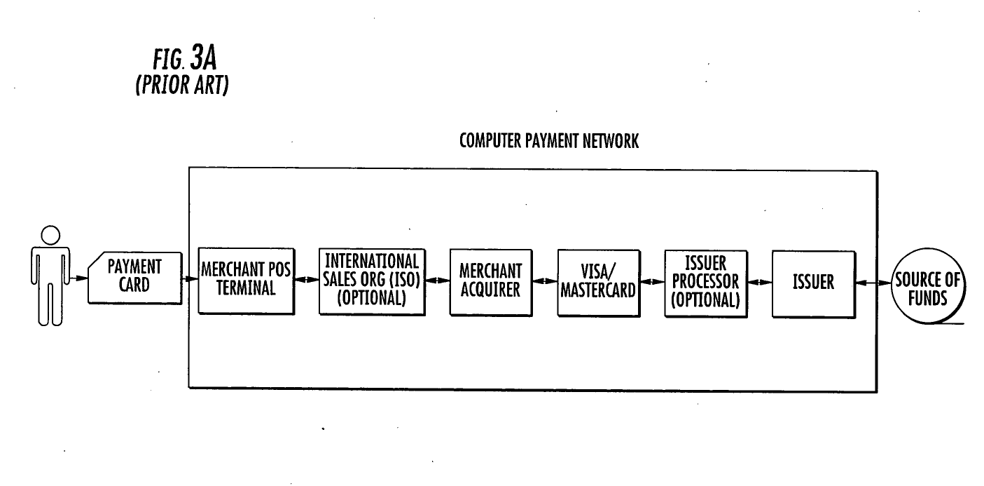

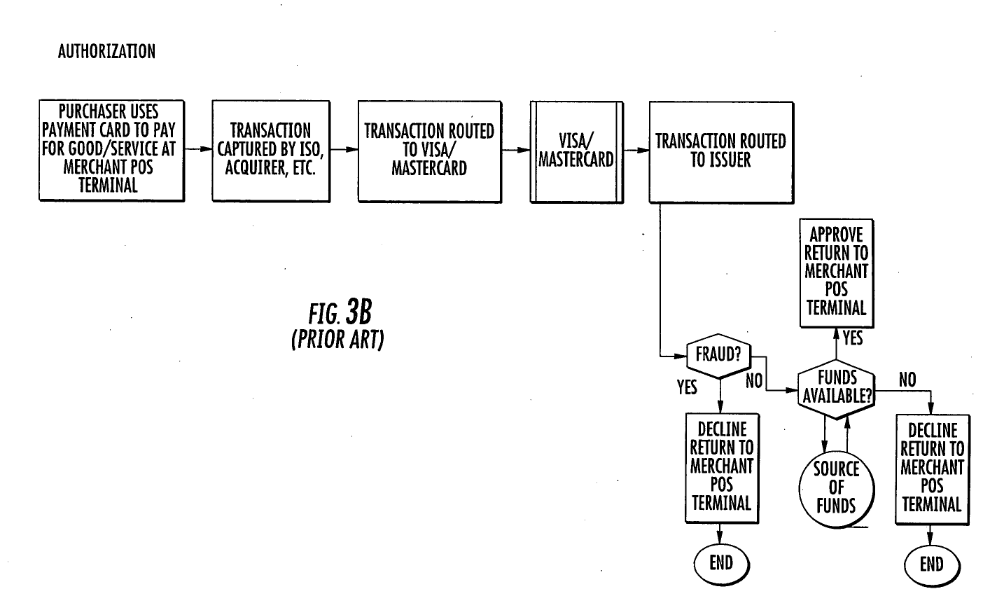

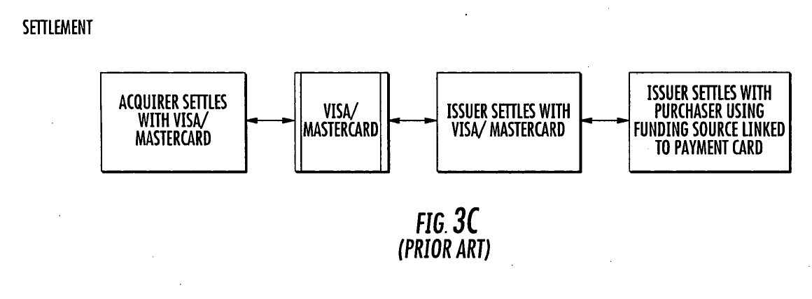

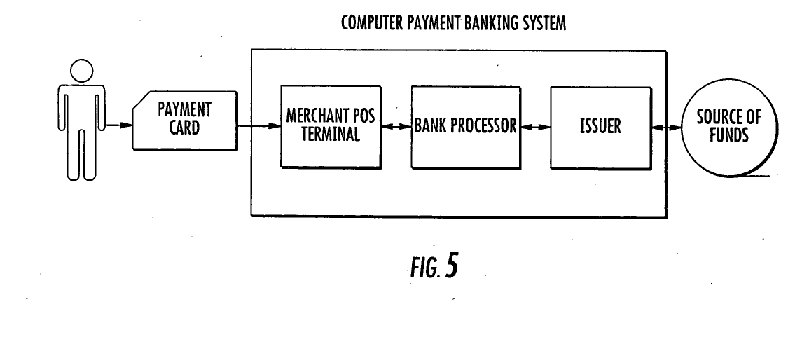

Referring to the figures, FIG. 5 illustrates the computer payment banking system of the present invention. As shown, the bank or other regulated financial institution serves as the bank processor. As compared to the existing prior art system of FIG. 3A, numerous processing steps and parties to the transaction are eliminated with the computer banking system of the present invention. Hence, not only is the payment processing transaction more efficient but there are other benefits to the merchant such as less interchange. As shown in FIG. 5, a purchaser uses a payment card associated with its sourced bank account to make a purchase at the merchant point of sale terminal. The merchant point of sale terminates uses the bank to process the payment for the purchase. The bank than communicates with the card issuer regarding the transaction and accesses the source of funds from the sourced bank account to consummate the purchase. It is within the scope of the present invention that the bank or other financial institution could also be the card issuer of the card associated with the sourced bank account.

The computer payment banking system and method of the present invention is particularly suitable for use by a purchaser to pay for items purchased online via the internet or world wide web. Among the purposes of the system and method of the present invention is to facilitate purchases from online vendors such as Amazon and Ebay, for example.

The system of the present invention provides for management of payments from vendors outside of online payments. This differs from existing systems because, for example, funds are guaranteed at a lower cost to merchant. It offers benefits to bank customers because makes transactions easier, offers greater security, and provides other sources of funds. The system of the present invention would be desirable to a merchant or vendor because it provides a less expensive alternative that current payment methods and avoids a portion of interchange fees.

A benefit of the system and method of the present invention to a user of the system is to alleviate the fear associated with providing specific account or personal information online during processing of a purchase or other payment transaction.

In the computer payment banking system of the present invention, the sourced bank account and associated information is typically prearranged between the bank and the user, as well as optionally the vendors, prior to the transaction. The transaction may be processed by many methods known in the industry including, but not limited to, an ACH type transaction or demand deposit account. The sourcing of funds for the sourced bank account allows the opportunity to source an account from one or more sources. The sourced bank account is optionally associated with non-bank lines of credit or deposit accounts. Tiered benefits such as rewards is optionally available for use with the sourced the bank account.

The sourced bank account of the system of the present invention is pre-funded. The sourced bank account is also available to be setup as a sweep account such that when new transactions arrive it will look among the selected sources for available funds. For example, the account holder could set a prioritized list of sources that should be accessed such that if funds from one source are unavailable, the sourced bank account will proceed to move to the next source on the list. The funds do not necessarily have to be insufficient funds to be unavailable but rather the account holder can establish rules as to when to source from another account such as use my checking account unless balance is $500 or below; if so, then use my credit card. The system of the present invention is able to source from accounts that are not within a single bank or a single financial institution.

Another feature provided with the system and method of the present invention is to provide the account holder with a unique identification number or a revolving identification for use on payment. Revolving identification refers to a disposable account number such as, for example, an account number set up for a one-time use. The identification would allow a sourced account holder to use one-click checkout functionality of online vendors. Identification theft prevention features include, but are not limited to, a pre-purchase short message service (SMS) alert notification and vendor block which is an option for blocking a vendor from completing a transaction. Instant fraud rules notification is an option for instant fraud reporting correspondence.

An advantage of the system and method of the present invention over existing systems and methods is that by virtue of the fact that the bank replaces certain other parties to a payment transaction and is not just a money service, the system of the present invention also has other unique features to provide to an account holder relating to its payment processing and sourced payment account. The features include, but are not limited to, the capability to set spending rules, reporting features for identity protection, computer-based access to conduct payment transactions and have access to the records of the account holder, trends in spending habits, and budget tools. By reference to computer or computer-based, the system and method of the present invention intends to include any device that provides web access, internet access, or other electronic access to a user including, but not limited to, a computer, mobile phone, automated teller machine (ATM), and personal data assistant.

Examples of other reporting features include, but are not limited to, a list of items purchased online during specified time frame such as yesterday, last week, last year and a financial analysis for online purchases such as for categories such as entertainment and food. These features are tied to personal and financial information that are of benefit to the account holder but could not be provided to the account holder but for the fact that the transactions are managed by a bank or other financial institution.

Still yet other advantages of the system and method of the present invention include, but are not limited to, consumer protection, efficiency in online purchases, and enhanced reporting of online purchases. Thus, the system of the present invention is attractive for new business and customer transactions by using a more secure payment process than existing processes.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A computer payment banking system comprising:
a bank or a financial institution that holds physical monetary funds,
a sourced bank account,
a holder of the sourced bank account, and
a merchant, wherein the bank or the financial institution uses monetary funds from the sourced bank account to pay the merchant in a computer-based payment system for an online web-based purchase associated with the sourced bank account or the holder of the sourced bank account.

2. The computer payment banking system according to claim 1, wherein the purchase is made with a credit instrument or a debit instrument associated with the sourced bank account.

3. The computer payment banking system according to claim 1, wherein online access to rewards, financial reports, budget tools, or spending information of the holder of the sourced bank account is provided by the bank or the financial institution to the holder of the sourced bank account.

4. The computer payment banking system according to claim 1, wherein a source of monetary funds for the sourced bank account is a checking account, credit instrument, debit instrument, online banking account, bank line of credit, non-bank line of credit, loan, financial account, or a combination thereof.

5. A computer payment banking system comprising:
a bank or a financial institution that holds physical monetary funds,
a sourced bank account,
a holder of the sourced bank account, and
a merchant, wherein the bank or the financial institution uses monetary funds from the sourced bank account to pay the merchant in a computer-based payment system for a purchase made using a credit instrument or a debit instrument associated with the sourced bank account.

6. The computer payment banking system according to claim 5, wherein online access to rewards, financial reports, budget tools, or spending information of the holder of the sourced bank account is provided by the bank or the financial institution to the holder of the sourced bank account.

7. The computer payment banking system according to claim 5, wherein a source of monetary funds for the sourced bank account is a checking account, credit instrument, debit instrument, online banking account, bank line of credit, non-bank line of credit, loan, financial account, or a combination thereof.

8. A computer payment banking system comprising:
a sourced bank account established by a bank or a financial institution that holds physical monetary funds, wherein a source of monetary funds for the sourced bank account are prearranged between the bank or the financial institution and a holder of the sourced bank account prior to a web-based payment transaction being processed by the bank or the financial institution for an online web-based purchase or refund in a computer-based payment system.

9. The computer payment banking system according to claim 8, wherein a source of monetary funds for the sourced bank account is a checking account, credit instrument, debit instrument, online banking account, bank line of credit, non-bank line of credit, loan, financial account, or a combination thereof.

10. The computer payment banking system according to claim 8, wherein the purchase is made with a credit instrument or a debit instrument associated with the sourced bank account.

11. The computer payment banking system according to claim 8, wherein online access to rewards, financial reports, budget tools, or spending information of the holder of the sourced bank account is provided by the bank or the financial institution to the holder of the sourced bank account

12. A method of using a computer payment banking system, the method comprising:
establishing a sourced bank account with a user by a bank or a financial institution that holds physical monetary funds, wherein the user is the holder of the sourced bank account, and
processing payments in a computer-based payment system using the sourced bank account for purchases made that are associated with the sourced bank account.

13. The method according to claim 12, wherein the purchases are made with a computer-based device.

14. The method according to claim 13, wherein the purchases are made from an online merchant.

15. The method according to claim 12, wherein the purchases are made with a credit instrument or a debit instrument.

16. The method according to claim 15, wherein the credit or debit instrument is tied to the sourced bank account.

17. The method according to claim 12, wherein the credit or debit instrument is issued by the bank or the financial institution.

18. The method according to claim 12, wherein a source of monetary funds for the sourced bank account is a checking account, credit instrument, debit instrument, online banking account, bank line of credit, non-bank line of credit, loan, financial account, or a combination thereof.
